(19) United States
(12) Patent Application Publication
(10) Pub. No.: US 2026/0056999 A1
(43) Pub. Date: Feb. 26, 2026

(54) INFORMATION MANAGEMENT APPARATUS, INFORMATION MANAGEMENT METHOD, STORAGE MEDIUM, AND INFORMATION MANAGEMENT SYSTEM

(71) Applicant: CANON KABUSHIKI KAISHA, Tokyo (JP)

(72) Inventor: KEI TAMAGAWA, Tokyo (JP)

(21) Appl. No.: 19/297,228

(22) Filed: Aug. 12, 2025

(30) Foreign Application Priority Data
Aug. 23, 2024 (JP) 2024-143345

(51) Int. Cl. G06F 16/34; G06F 16/16

(52) U.S. Cl. CPC G06F 16/345; G06F 16/162

(57) ABSTRACT

An information management apparatus manages data and includes a request unit to make a request to generate summary information of the data to a summary generation apparatus, a deletion unit to delete the data, and a re-request control unit to control whether to make a re-request to generate the summary information of the data to the summary generation apparatus, depending on a type of a response to the request and whether the data is present. The re-request control unit performs control to make the re-request in a case where the type of the response is a failure to obtain the data by the summary generation apparatus and the data is present, and performs control to cancel the re-request in a case where the data is not present even though the type of the response is the failure to obtain the data by the summary generation apparatus.

### BACKGROUND

### Field of the Technology

The present disclosure relates to an information management apparatus, an information management method, a program, and an information management system.

### Description of the Related Art

There is an image management cloud service that manages images uploaded from cameras of users. The image management cloud service generates summary information of each of managed images, which enables a user to identify what type of image the managed image is, such as a thumbnail, image capture information, and image feature quantities, and presenting the summary information to the user. The image management cloud service of this type may fail in generation and other operations. In this regard, Japanese Patent Laid-Open No. 2009-276936 discloses a technique for performing a process depending on a type of a failure.

### SUMMARY

An information management apparatus according to an aspect of the technology of the present disclosure is an information management apparatus configured to manage data, including: a request unit configured to make a request to generate summary information of the data to a summary generation apparatus configured to generate the summary information; a deletion unit configured to delete the data; and a re-request control unit configured to control whether to make a re-request to generate the summary information of the data to the summary generation apparatus, depending on a type of a response to the request and whether the data is present. The re-request control unit performs control to make the re-request to generate the summary information of the data to the summary generation apparatus in a case where the type of the response is a failure to obtain the data by the summary generation apparatus and the data is present, and performs control to cancel the re-request to generate the summary information of the data to the summary generation apparatus in a case where the data is not present even though the type of the response is the failure to obtain the data by the summary generation apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overview of an information management system;

FIG. 2 is a diagram illustrating an example of a configuration of an information management system;

FIG. 3 is a diagram illustrating an example of a hardware configuration of a terminal;

FIG. 4 is a diagram illustrating an example of a hardware configuration of an information processing apparatus;

FIG. 5 is a diagram illustrating an example of a functional configuration of the information management system;

FIG. 6 is a sequence chart illustrating a flow of processing in the entire information management system;

FIG. 7 is a diagram showing the relationship of FIG. 7A and FIG. 7B;

FIGS. 7A and 7B are sequence charts illustrating the flow of the processing in the entire information management system;

FIG. 8 is a diagram for describing a flow of processing by an information management apparatus;

FIG. 9 is a flowchart illustrating a detailed flow of determination processing;

FIG. 10 is a flowchart illustrating a detailed flow of error cause category determination processing;

FIG. 11 is a flowchart illustrating a detailed flow of presence determination processing;

FIGS. 12A and 12B are diagrams illustrating examples of tables;

FIG. 13 is a diagram illustrating examples of error codes;

FIG. 14 is a diagram illustrating an example of an error cause category table;

FIG. 15 is a diagram illustrating an example of a functional configuration of an information management system;

FIG. 16 is a diagram for describing a flow of processing in an information management apparatus;

FIG. 17 is a diagram illustrating an example of a functional configuration of an information management system; and

FIG. 18 is a diagram illustrating an example of a past result display screen.

### DESCRIPTION OF THE EMBODIMENTS

Embodiments of the technology of the present disclosure will be described below in detail with reference to the drawings. Note that the configurations described in the following embodiments are mere examples, and embodiments are not limited to the illustrated configurations. Also, the following embodiments do not limit the technology of the present disclosure according to the claims. Not all of the features in combination described in the embodiments are necessarily essential for the solution to be provided by the technology of the present disclosure, and multiple features may be combined in any ways. Herein, identical components will be described with the same reference sign given thereto. Also, each of the processes (steps) in the flowcharts is denoted with a prefix “S.”

### First Embodiment

An information management system according to a first embodiment will now be described.

### Overview of Information Management System 100

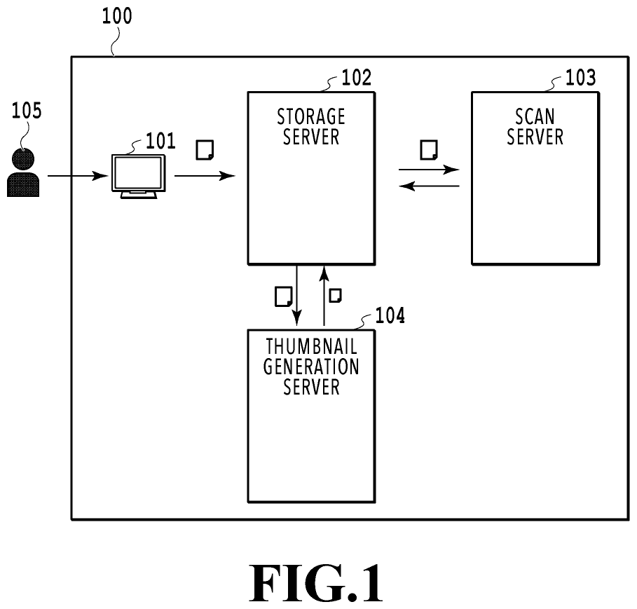

FIG. 1 is a diagram illustrating an overview of the information management system according to the present embodiment. As illustrated in FIG. 1, an information management system 100 has a personal computer (hereinafter referred to as “PC”) 101, a storage server 102, a scan server 103, and a thumbnail generation server 104. The storage server 102 provides an image management cloud service that manages image files and presents summary information of images to a user. The scan server 103 provides a virus scanning service that verifies whether uploaded images are infected with viruses, and takes a measure to prevent the user from accessing images in a case where they are infected. The thumbnail generation server 104 serves as a summary information generation micro service (hereinafter also abbreviated as “MS”) having a summary information generation function to generate summary information of images. The thumbnail generation server 104 provides a service that generates the summary information of images.

A user 105 having an account for the storage server 102 uses the information management system 100 by operating the PC 101. The PC 101 has a communication function and is capable of transmitting files 111 to the storage server 102.

The storage server 102 has a communication function and is capable of communicating with external apparatuses such as the PC 101 and the scan server 103. The storage server 102 manages files 111 uploaded from the PC 101 by operations by the user 105. The storage server 102 accepts uploading of any types of files 111, such as document files, image files, video files, audio files, and executable files, from the PC 101 and manages the uploaded files.

The scan server 103 has a communication function and is capable of communicating with the storage server 102. The thumbnail generation server 104 has a communication function and is capable of communicating with the storage server 102.

Hereinafter, processing to be executed by the information management system 100 in the present embodiment will be described.

The user 105 transmits a file stored in the PC 101 to the storage server 102 by operating the PC 101. The storage server 102 transfers the received file to the scan server 103 and requests the scan server 103 to inspect the file. The scan server 103 inspects the received file and transmits the inspection result to the storage server 102.

The storage server 102 receives the inspection result and determines whether the inspection result indicates “valid.” If determining that the inspection result indicates “valid,” the storage server 102 requests the thumbnail generation server 104 to generate the summary information of the file.

In response to receiving the request to generate the summary information of the file from the storage server 102, the thumbnail generation server 104 generates the summary information of the file and notifies the storage server 102 of a reference to the generated summary information of the file, the reference specifying a location where the summary information is stored.

In response to receiving the notification indicating the reference to the summary information of the file from the thumbnail generation server 104, the storage server 102 obtains the summary information of the file from the location specified by the reference to the summary information of the file specified by the received notification.

### Information Management System

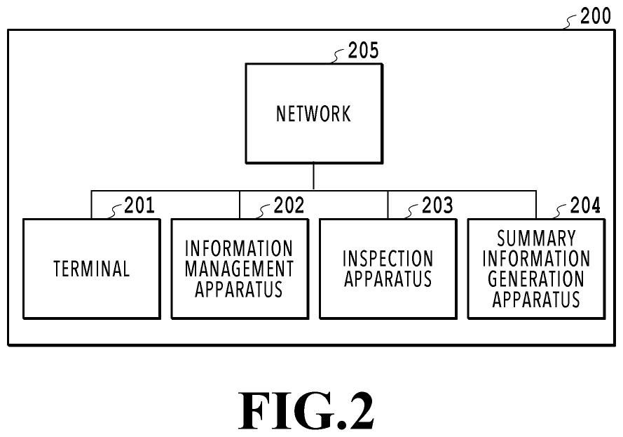

FIG. 2 is a diagram illustrating an example of a configuration of an information management system according to the present embodiment. As illustrated in FIG. 2, an information management system 200 has a terminal 201, an information management apparatus 202, an inspection apparatus 203, a summary information generation apparatus (summary generation apparatus) 204, and a network 205. The terminal 201, the information management apparatus 202, the inspection apparatus 203, the summary information generation apparatus 204 function as the PC 101, the storage server 102, the scan server 103, and the thumbnail generation server 104 in FIG. 1, respectively.

The terminal 201, the information management apparatus 202, the inspection apparatus 203, and the summary information generation apparatus 204 are connected so as to be capable of transmitting and receiving files to and from one another through the network 205. The network 205 is implemented using, for example, a local area network (LAN), the Internet, or the like, and allows mutual communication between apparatuses connected to the network 205. The terminal 201 is described herein as a PC having a communication function as an example, but is not limited to this. The terminal 201 may be any terminal apparatus having a communication function and being capable of transmitting files to the information management apparatus 202, such, for example, as an interchangeable-lens digital camera, a compact digital camera, a smartphone, or a tablet.

### Hardware Configuration of Terminal

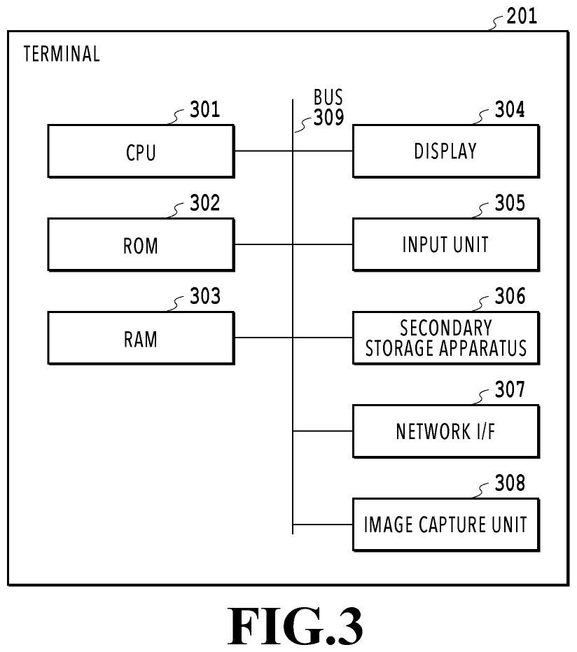

FIG. 3 is a diagram illustrating an example of a hardware configuration of the terminal 201. The terminal 201 has a central processing unit (CPU) 301, a read-only memory (ROM) 302, a random-access memory (RAM) 303, a display 304, an input unit 305, a secondary storage apparatus 306, a network interface (I/F) 307, and an image capture unit 308. These components are connected so as to be capable of transmitting and receiving data to and from one another through a bus 309. Although examples of the terminal 201 include an interchangeable-lens digital camera and a compact digital camera, the terminal 201 is not limited to these and may be a smartphone, a tablet terminal, or the like having a camera function.

The CPU 301 is an arithmetic processing apparatus that loads programs stored in the ROM 302 and the secondary storage apparatus 306 to the RAM 303 and executes them to control the components connected to the CPU 301 through the bus 309. The ROM 302 is a read-only memory that stores an operating system (OS) and the like. The RAM 303 is a random-access memory that temporarily stores data for use in execution of arithmetic processing by the CPU 301. The display 304 is a display apparatus that displays information necessary for the user, such as captured images and various user interface (UI) screens. The input unit 305 is an input apparatus that includes buttons, a touch panel, a microphone, and the like and accepts various user operations, such as an image capture instruction and various setting instructions. The secondary storage apparatus 306 stores various programs, captured image data, the setting values of image capture settings contained in additional information, and the like. Here, the image capture settings include ISO sensitivity, shutter speed, exposure compensation, f-number, and the like.

The network I/F 307 is an interface for connecting with a network, such as a LAN, an intranet, or the Internet. The image capture unit 308 is a module that converts light received by an image sensor, such as a charge coupled device (CCD) or a complementary metal oxide semiconductor (CMOS) sensor, into electrical signals and records them as an image.

### Hardware Configuration of Information Processing Apparatus

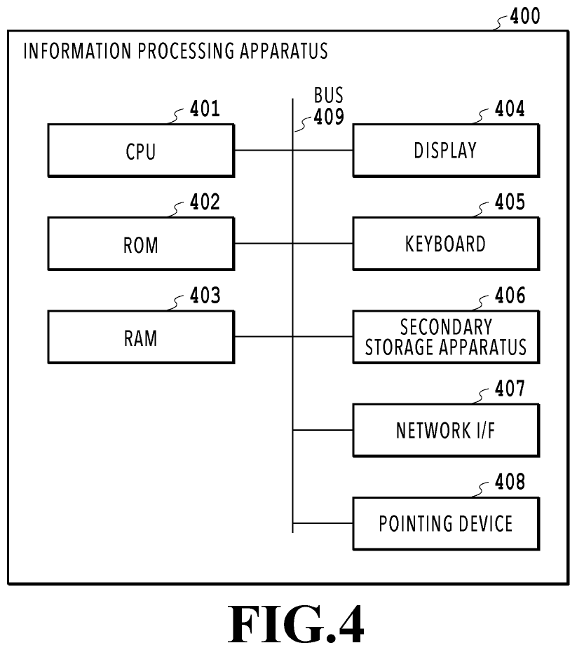

FIG. 4 is a diagram illustrating an example of a hardware configuration of an information processing apparatus 400 capable of functioning as the information management apparatus 202, the inspection apparatus 203, and the summary information generation apparatus 204. The information processing apparatus 400 has a CPU 401, a ROM 402, a RAM 403, a display 404, a keyboard 405, a secondary storage apparatus 406, a network I/F 407, and a pointing device 408. These components are connected so as to be capable of transmitting and receiving data to and from one another through a bus 409.

The CPU 401 is an arithmetic processing apparatus that loads programs stored in the ROM 402 and the secondary storage apparatus 406 to the RAM 403 and executes them to control the components connected to the CPU 401 through the bus 409. The ROM 402 is a read-only memory that stores an OS and the like. The RAM 403 is a random-access memory that temporarily stores data for use in execution of arithmetic processing by the CPU 401. The display 404 is a display apparatus that displays UI screens and the like. The keyboard 405 and the pointing device 408 are input apparatuses for the user to perform various input operations. The secondary storage apparatus 406 stores various programs, setting value data, databases (DBs), capture image data, and the like. The network I/F 407 is an interface for connecting with a network, such as a LAN, an intranet, or the Internet.

### Functional Configuration of Information Management System

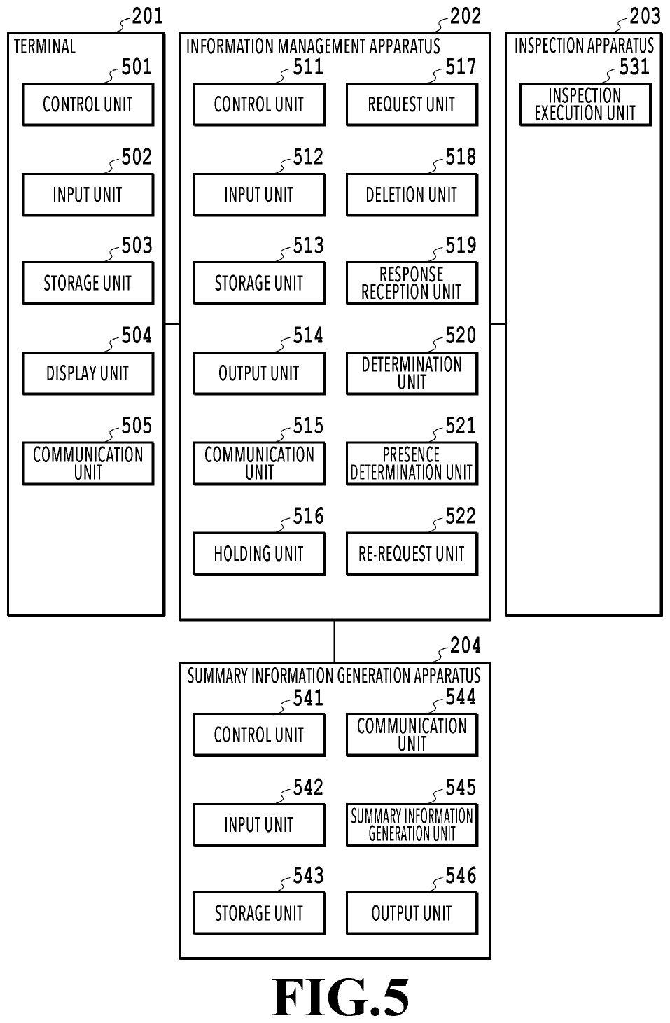

FIG. 5 is a diagram illustrating an example of a functional configuration of the information management system according to the present embodiment.

### Functional Configuration of Terminal

The CPU 301 of the terminal 201 loads programs stored in the ROM 302 to the RAM 303 and executes the programs according to sequence charts and flowcharts to be described later to implement the functional configuration. Note that the result of each executed process is held in the RAM 303.

The terminal 201 has a control unit 501, an input unit 502, a storage unit 503, a display unit 504, and a communication unit 505. Each functional unit will now be described below. Note that each of the functional units may perform part of functions of any other functional unit.

The control unit 501 controls the components of the terminal 201. The input unit 502 accepts user inputs. The storage unit 503 stores a program for transmitting images to the information management apparatus 202, images to be transmitted to the information management apparatus 202, user inputs, and the like. The display unit 504 displays an input screen for transmitting an image to the information management apparatus 202, a transmission result, summary information of an image in the information management apparatus 202, and the like.

The communication unit 505 exchanges data with the information management apparatus 202 using the network I/F 307. The communication unit 505 performs communication such as transmitting an image designated by the user, receiving information on a list of images managed by the information management apparatus 202, transmitting an operation on an image managed by the information management apparatus 202, and receiving the operation result.

### Functional Configuration of Information Management Apparatus

The CPU 401 of the information processing apparatus 400 that functions as the information management apparatus 202 loads programs stored in the ROM 402 to the RAM 403 and executes the programs according to sequence charts and flowcharts to be described later to implement the functional configuration. Note that the result of each executed process is held in the RAM 403.

The information management apparatus 202 has a control unit 511, an input unit 512, a storage unit 513, an output unit 514, a communication unit 515, a holding unit (data holding unit) 516, a request unit 517, a deletion unit 518, a response reception unit 519, a determination unit 520, a presence determination unit 521, and a re-request unit 522. Each functional unit will now be described below. Note that each of the functional units may perform part of functions of any other functional unit.

The control unit 511 controls the components of the information management apparatus 202. The input unit 512 accepts user inputs. The storage unit 513 stores programs to run on the information management apparatus 202, inputs from the terminal 201, the inspection apparatus 203, and the summary information generation apparatus 204, and the like.

The output unit 514 outputs processing results of the information management apparatus 202, images held by the holding unit 516, and the like. The communication unit 515 exchanges data with the terminal 201, the inspection apparatus 203, and the summary information generation apparatus 204 using the network I/F 407.

The holding unit 516 holds images received from the terminal 201 (uploaded images), inspection results received from the inspection apparatus 203, summary information obtained from the summary information generation apparatus 204, and the like. On the occasion of execution of holding, the holding unit 516 issues an event associated with the execution of holding. In a case where an event is issued, a process block set to receive an event can be notified of the event.

The request unit 517 requests the summary information generation apparatus 204 to generate the summary information of an image. The deletion unit 518 deletes an uploaded image based on a response from the inspection apparatus 203. The response reception unit 519 receives a response to the request to generate the summary information of the image from the summary information generation apparatus 204.

The determination unit 520 determines a subsequent process to be executed by the information management apparatus 202 according to the type of the received response. In a case where the type of the received response is a type indicating a failure to obtain an image by the summary information generation apparatus 204, the presence determination unit 521 determines whether the target image is present among the images held by the holding unit 516. In a case where the image is determined to be present, the re-request unit 522 re-requests the summary information generation apparatus 204 to generate the summary information of the target image.

### Functional Configuration of Inspection Apparatus

The CPU 401 of the information processing apparatus 400 that functions as the inspection apparatus 203 loads programs stored in the ROM 402 to the RAM 403 and executes the programs according to sequence charts and flowcharts to be described later to implement the functional configuration. Note that the result of each executed process is held in the RAM 403. Note that each of the functional units may perform part of functions of any other functional unit.

The inspection apparatus 203 has an inspection execution unit 531. In response to receiving a request to inspect an image from the information management apparatus 202, the inspection execution unit 531 inspects the image.

### Functional Configuration of Summary Information Generation Apparatus

The CPU 401 of the information processing apparatus 400 that functions as the summary information generation apparatus 204 loads programs stored in the ROM 402 to the RAM 403 and executes the programs according to sequence charts and flowcharts to be described later to implement the functional configuration. Note that the result of each executed process is held in the RAM 403.

The summary information generation apparatus 204 has a control unit 541, an input unit 542, a storage unit 543, a communication unit 544, a summary information generation unit 545, and an output unit 546. Each functional unit will now be described below.

The control unit 541 controls the components of the summary information generation apparatus 204. The input unit 542 accepts user inputs. The storage unit 543 stores programs to run on the summary information generation apparatus 204, inputs from the information management apparatus 202, and the like. The communication unit 544 exchanges data with the information management apparatus 202 using the network I/F 407.

The summary information generation unit 545 generates the summary information of an image based on a request to generate the summary information of the image from the information management apparatus 202. The output unit 546 outputs processing results by the summary information generation apparatus 204, the summary information of images generated by the summary information generation unit 545, and the like.

### Flow of Processing in Information Management System

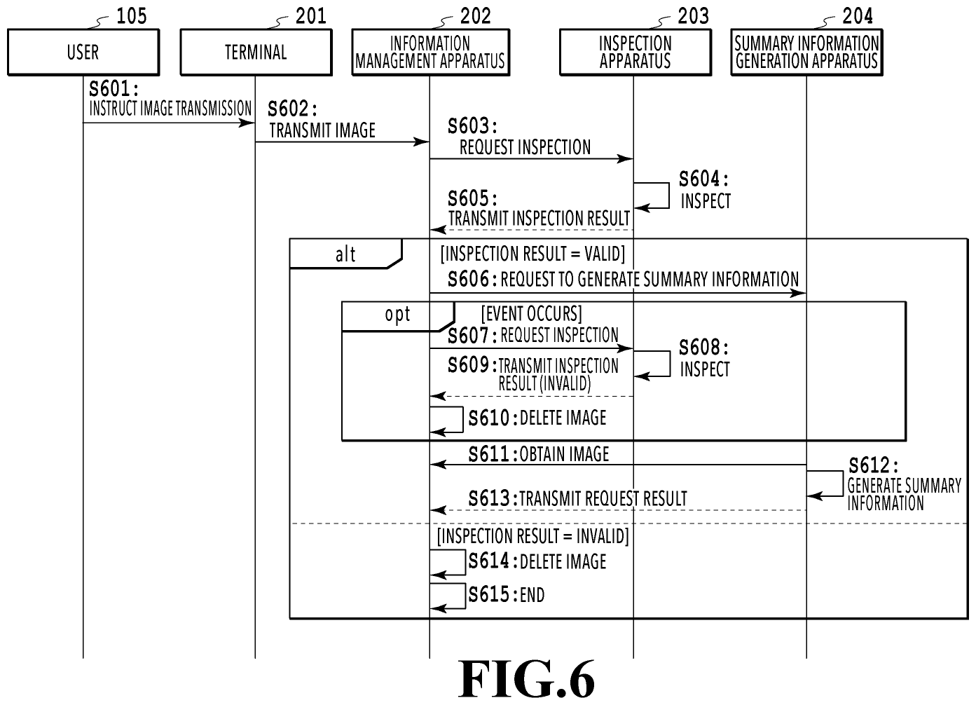

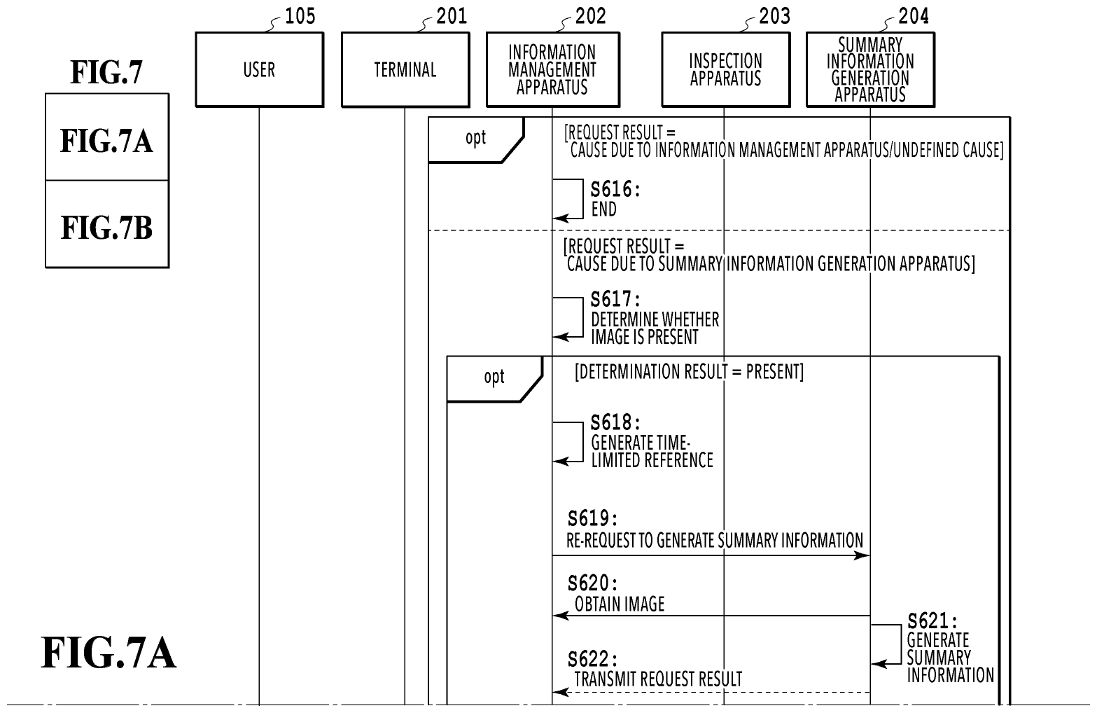

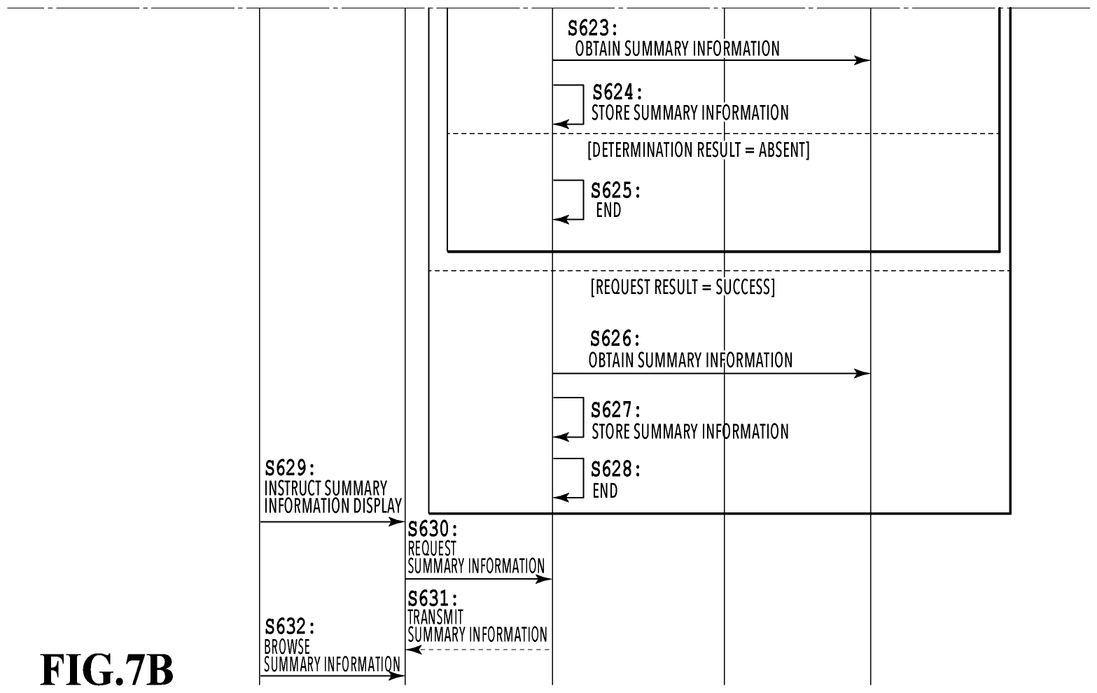

A flow of processing in the information management system 200 in the present embodiment will now be described using the sequence charts illustrated in FIGS. 6 and 7. In the sequence charts, “alt” represents a branch point and defines which of branched processes is to be executed depending on an immediately-previous result in the sequence. Also, “opt” defines a process to be executed only in a case where a result of the preceding process satisfies a given condition.

In S601, the user 105 instructs the terminal 201 to transmit an image through the input unit 305. In S602, based on the image transmission instruction from the input unit 305, the terminal 201 transmits the image to the information management apparatus 202.

In S603, in response to receiving the image, the information management apparatus 202 requests the inspection apparatus 203 to inspect the image. In S604, the inspection apparatus 203 inspects the received image. As a result of executing the inspection, the inspection apparatus 203 obtains an inspection result indicating “valid” or an inspection result indicating “invalid.” In S605, the inspection apparatus 203 transmits the inspection result to the information management apparatus 202.

The information management apparatus 202 performs the processes of S606 to S613 if receiving the inspection result indicating “valid” from the inspection apparatus 203, and performs the processes of S614 and S615 if receiving the inspection result indicating “invalid”from the inspection apparatus 203.

In S606, the information management apparatus 202 requests the summary information generation apparatus 204 to generate the summary information of the image, since the inspection result indicating “valid”is received.

Now, processing in a case where a reception event occurs will be described. Note that the reception event is not caused intentionally but is caused due to constraints originating from the platform on which the information management apparatus 202 is constructed, and therefore is a phenomenon that occurs unintentionally with a certain probability.

In S607, in response to the occurrence of a reception event, the information management apparatus 202 unintentionally issues a request to inspect the image to the inspection apparatus 203 again.

In S608, the inspection apparatus 203 inspects the received image based on the inspection request in S607. In this inspection, a virus definition file of the inspection apparatus 203 is updated, and the inspection apparatus 203 determines that the image is an invalid file. In S609, the inspection apparatus 203 transmits the inspection result indicating “invalid” to the information management apparatus 202. In S610, the information management apparatus 202 receives the inspection result indicating “invalid” and deletes the image inspected in S608.

In S611, based on the request in S606, the summary information generation apparatus 204 tries to obtain the target image from the information management apparatus 202 in order to generate the summary information of the image. If no reception event occurred, the target image is present in the information management apparatus 202, and the summary information generation apparatus 204 thus obtains the target image from the information management apparatus 202. On the other hand, if a reception event occurred, the target image is already deleted in S610 and is not present in the information management apparatus 202, and the summary information generation apparatus 204 thus fails to obtain the target image from the information management apparatus 202.

In S612, the summary information generation apparatus 204 tries to generate the summary information. If no reception event occurred, the summary information generation apparatus 204 generates the summary information of the target image from the target image obtained in S611. On the other hand, if a reception event occurred, the summary information generation apparatus 204 fails to obtain the target image in S611 and thus fails to generate the summary information of the target image. In S613, the summary information generation apparatus 204 transmits the request result for the summary information generation request to the information management apparatus 202.

In S614, the information management apparatus 202 deletes the target image since the inspection result indicating “invalid” is received. In S615, the information management apparatus 202 terminates the process based on the inspection result transmitted from the inspection apparatus 203.

The information management apparatus 202 performs a process or processes depending on a content of the request result transmitted from the inspection apparatus 203, namely, “cause due to the information management apparatus/undefined cause,” “cause due to the summary information generation apparatus,” or “success.” The information management apparatus 202 performs the process of S616 if receiving a request result indicating “cause due to the information management apparatus” or “undefined cause.” The information management apparatus 202 performs the processes of S617 to S625 if receiving a request result indicating “cause due to the summary information generation apparatus.” The information management apparatus 202 performs the processes of S626 to S628 if receiving a request result indicating “success.”

In S616, the information management apparatus 202 terminates the processing in the information management apparatus 202 because the request result indicating the cause due to the information management apparatus 202 or an undefined cause is received.

In S617, the information management apparatus 202 determines whether the image is present because the request result indicating the cause due to the summary information generation apparatus 204 is received.

Now, processes to be executed depending on a processing result of determination of whether the image is present will be described. The information management apparatus 202 performs the processes of S618 to S624 if receiving the determination result indicating “present”, and performs the process of S625 if receiving the determination result indicating “absent”.

In S618, the information management apparatus 202 generates a time-limited reference to the image because the determination result indicating the presence of the image is obtained. The time-limited reference to the image indicates a reference location that allows access to or obtaining of the image only within a preset period. The time limit for the reference is set to, for example, one hour, but is not limited to this. In a case where the apparatuses perform communication in a communication environment with relatively-high safety, the time limit for the reference may be set to a time longer than one hour. In a case where the apparatuses perform communication in a communication environment with relatively-low safety, the time limit for the reference may be set to a time shorter than one hour.

In S619, the information management apparatus 202 re-requests the summary information generation apparatus 204 to generate the summary information of the image.

In S620, the summary information generation apparatus 204 obtains the image from the information management apparatus 202. In S621, the summary information generation apparatus 204 generates the summary information of the image obtained in S620. In S622, the summary information generation apparatus 204 transmits a request result to the information management apparatus 202. The request result contains a time-limited reference specifying a location where the summary information is stored. In S623, the information management apparatus 202 obtains the time-limited reference to the summary information from the received request result and obtains the summary information from the location specified by the reference. In S624, the information management apparatus 202 stores the summary information obtained in S623 to the holding unit 516.

In S625, the information management apparatus 202 terminates the processing in the information management apparatus 202 because the determination result indicating the absence of the image is obtained.

In S626, the information management apparatus 202 obtains the time-limited reference to the summary information from the received request result since the request result indicating success is received, and obtains the summary information of the target image from the location specified by the reference. In S627, the information management apparatus 202 stores the summary information of the target image obtained in S626 to the holding unit 516. In S628, the information management apparatus 202 terminates the processing in the information management apparatus 202.

In S629, the user 105 instructs the terminal 201 to display the summary information of the image through the input unit 305. In S630, the terminal 201 requests the summary information of the image from the information management apparatus 202 based on the instruction to display the summary information of the image from the input unit 305. In S631, the information management apparatus 202 transmits the summary information of the image relevant to the request in S630 to the terminal 201. The terminal 201 receives the summary information transmitted from the information management apparatus 202 and displays the summary information on the display unit 504. In S632, the user 105 browses the summary information of the image displayed on the display unit 504.

### Flow of Processing in Information Management Apparatus 202

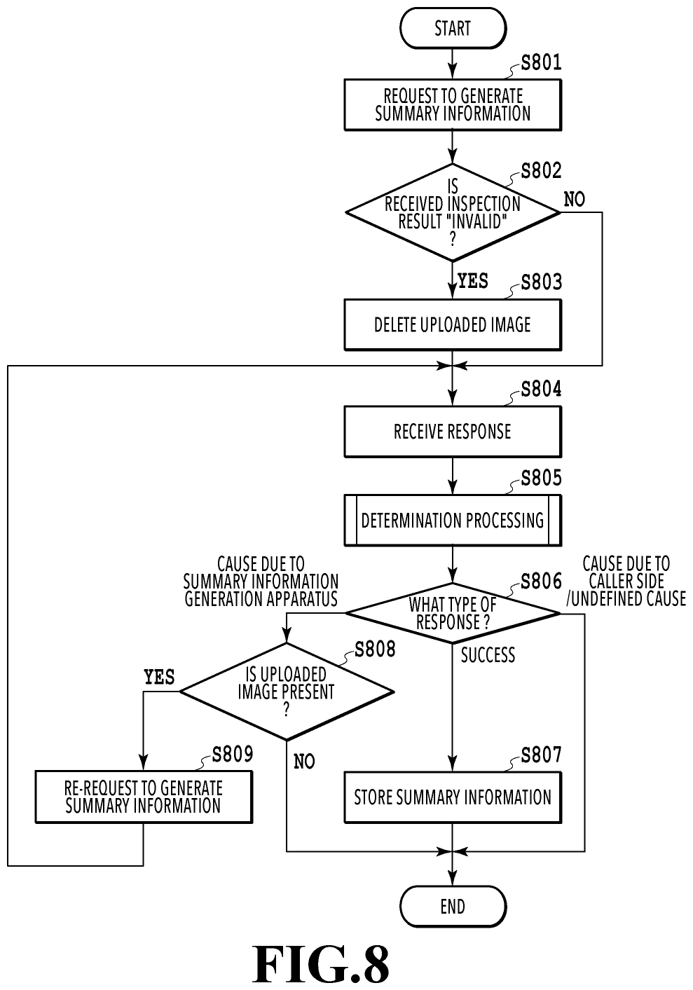

FIG. 8 is a diagram for describing a flow of processing to be executed by the information management apparatus 202.

In S801, the request unit 517 requests the summary information generation apparatus 204 to generate the summary information of an image uploaded to the information management apparatus 202.

In S802, the deletion unit 518 determines whether an inspection result received from the inspection apparatus 203 indicates “invalid.” If the determination result is false (NO in S802), the processing moves to S804. As described above, in a case where the received inspection result indicates not “invalid” but “valid,” the processing skips S803, so that the uploaded image is not deleted. If the determination result is true (YES in S802), the processing moves to S803. In S803, the deletion unit 518 deletes the uploaded image.

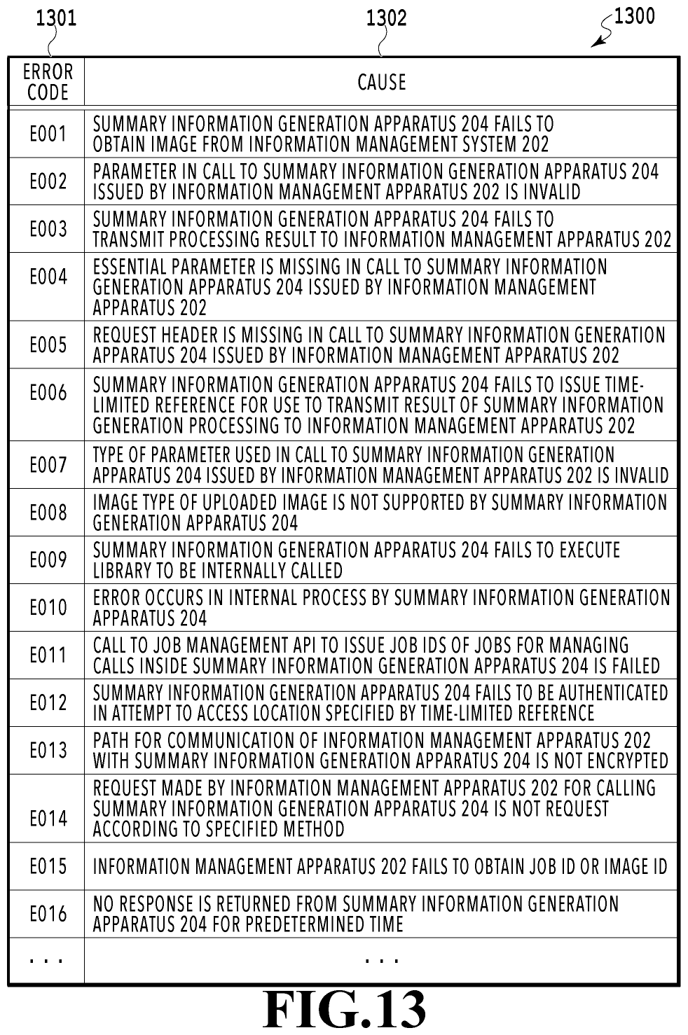

In S804, the response reception unit 519 receives a request result response from the summary information generation apparatus 204. The request result response, i.e., response information, indicates a success or an error. In the case of an error, the response information contains an error code. FIG. 13 presents error codes each of which is output from the summary information generation apparatus 204 on the occasion of an error. Error causes specified by the respective error codes are as follows.
The summary information generation apparatus 204 fails to obtain an image from the information management apparatus 202
A parameter used in a call to the summary information generation apparatus 204 issued by the information management apparatus 202 is invalid
The summary information generation apparatus 204 fails to transmit a processing result to the information management apparatus 202
An essential parameter is missing in a call to the summary information generation apparatus 204 issued by the information management apparatus 202
A request header is missing in a call to the summary information generation apparatus 204 issued by the information management apparatus 202
The summary information generation apparatus 204 fails to issue a time-limited reference for use to transmit a result of the summary information generation processing to the information management apparatus 202
The type of a parameter used in a call to the summary information generation apparatus 204 issued by the information management apparatus 202 is invalid
The image type of the uploaded image (the data format of the data) is not supported by the summary information generation apparatus 204
The summary information generation apparatus 204 fails to execute a library to be internally called, due to a corrupted image or the like
An error occurs in an internal process by the summary information generation apparatus 204
A call to a job management application programming interface (API) is failed, the job management API configured to issue job IDs of jobs for managing calls inside the summary information generation apparatus 204
The summary information generation apparatus 204 fails to be authenticated in an attempt to access a location specified by time-limited reference
The path for communication of the information management apparatus 202 with the summary information generation apparatus 204 is not encrypted
A request made by the information management apparatus 202 for calling the summary information generation apparatus 204 is not a request according to a specified method
The information management apparatus 202 fails to obtain a job ID or an image ID
No response is returned from the summary information generation apparatus 204 for a predetermined time

The job management API is incorporated in the summary information generation apparatus 204. In response to receiving a summary information generation request, the summary information generation apparatus 204 transmits the request to the job management API. The job management API manages the request as a job. For this purpose, the job management API issues a job ID for identifying the job. By being notified of this job ID, the sender of the summary information generation request can inquire about the progress of the job by using the job ID. The information management apparatus 202 also transmits a job ID to the summary information generation apparatus 204 in making an inquiry about the progress of the summary information generation or making a request to obtain the summary information.

In S805, the determination unit 520 determines a subsequent process to be executed by the information management apparatus 202 according to the type of the received response.

### Details of Determination Processing

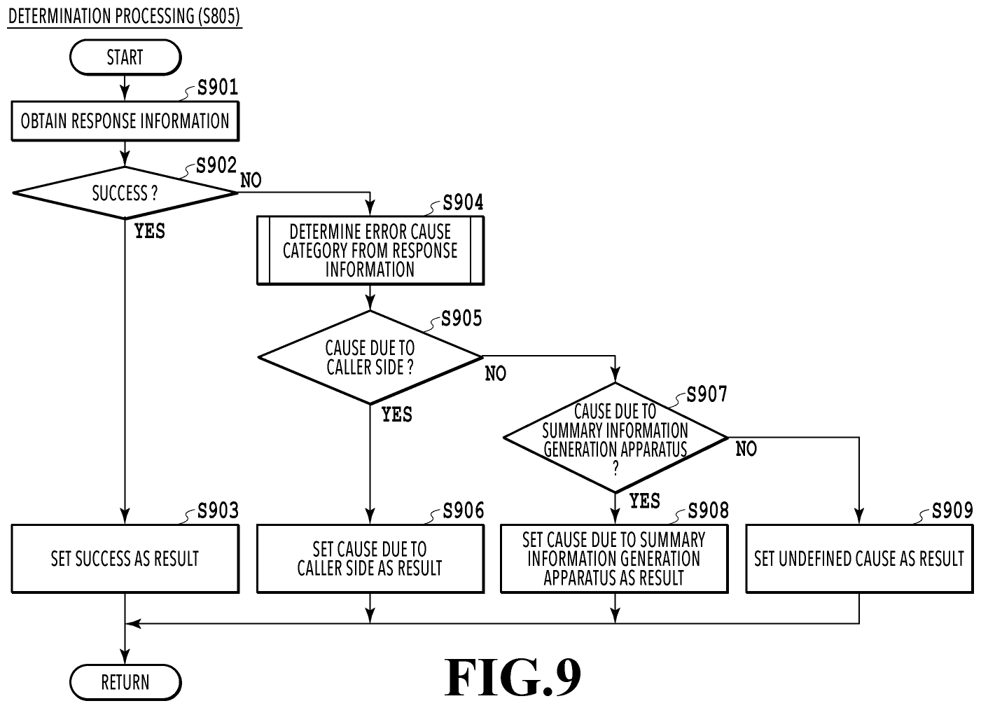

FIG. 9 is a flowchart illustrating a detailed flow of the determination processing (S805). The determination unit 520 executes the determination processing.

In S901, the determination unit 520 obtains the response information indicating the request result response. In S902, the determination unit 520 determines whether a result attribute in the response information obtained in S901 is success. If it is determined that the result attribute is success (YES in S902), the processing moves to S903. If it is determined that the result attribute is not success (NO in S902), the processing moves to S904.

In S903, the determination unit 520 sets a value indicating success in the request result as the processing result by the determination unit 520.

In S904, the determination unit 520 determines an error cause category from the response information obtained in S902.

### Details of Error Cause Category Determination Processing

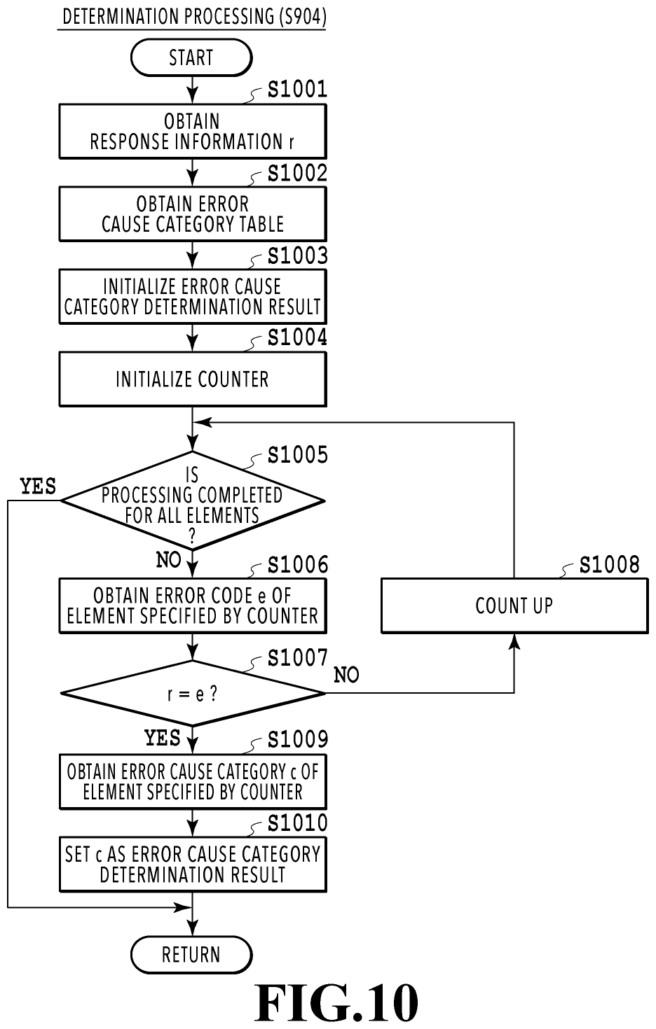

FIG. 10 is a flowchart illustrating a detailed flow of the error cause category determination processing (S904). The determination unit 520 executes the error cause category determination processing (S904).

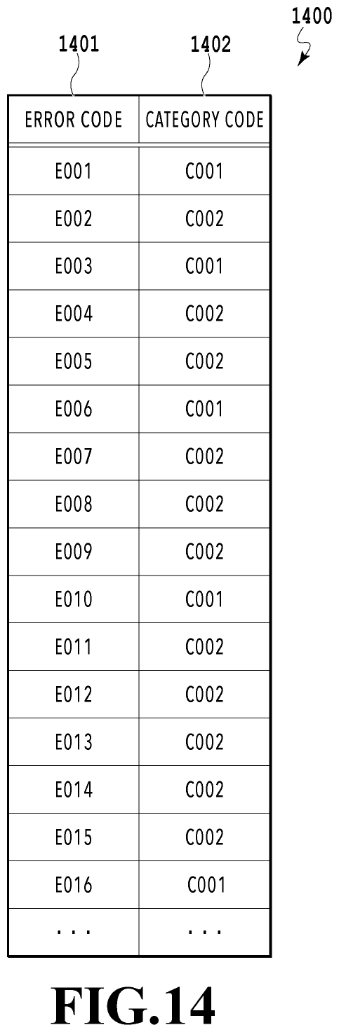

In S1001, the determination unit 520 obtains response information r. The response information r is the response information obtained in S901. In S1002, the determination unit 520 obtains an error cause category table. Details of the error cause category table will be described later using FIG. 14. In S1003, the determination unit 520 initializes an error cause category determination result. In S1004, the determination unit 520 initializes a counter.

In S1005, the determination unit 520 determines whether the processing is completed for all elements. If it is determined that the processing is not completed for all the elements (NO in S1005), the processing moves to S1006. If it is determined that the processing is completed for all the elements (YES in S1005), the processing in FIG. 10 is terminated.

In S1006, the determination unit 520 obtains an error code e of an element specified by the counter. In S1007, the determination unit 520 determines whether the error code specified in the response information matches the error code obtained in S1006. If it is determined that the error code specified in the response information matches the error code obtained in S1006 (YES in S1007), the processing moves to S1009. If it is determined that the error code specified in the response information does not match the error code obtained in S1006 (NO in S1007), the processing moves to S1008.

In S1008, the determination unit 520 counts up the counter. After the process of S1008 is completed, the processing moves to S1005.

In S1009, the determination unit 520 obtains an error cause category c of the element specified by the counter. In S1010, the determination unit 520 sets c as the processing result in S904 (error cause category determination result). After the processing result is set, the flow in FIG. 10 is terminated.

The description now returns to FIG. 9. In S905, the determination unit 520 determines whether the error cause, which is the error cause category determination result in S904, is a cause due to the caller side. If the determination result is true (YES in S905), the processing moves to S906. If the determination result is false (NO in S905), the processing moves to S907.

The causes due to the caller side are as follows.
A parameter used in a call to the summary information generation apparatus 204 issued by the information management apparatus 202 is invalid
An essential parameter is missing in a call to the summary information generation apparatus 204 issued by the information management apparatus 202
A request header is missing in a call to the summary information generation apparatus 204 issued by the information management apparatus 202
The type of a parameter used in a call to the summary information generation apparatus 204 issued by the information management apparatus 202 is invalid
The image type of the uploaded image is not supported by the summary information generation apparatus 204
The summary information generation apparatus 204 fails to execute a library to be internally called
A call to a job management API to issue job IDs of jobs for managing calls inside the summary information generation apparatus 204 is failed
The summary information generation apparatus 204 fails to be authenticated in an attempt to access a location specified by a time-limited reference
The path for communication of the information management apparatus 202 with the summary information generation apparatus 204 is not encrypted
A request made by the information management apparatus 202 for calling the summary information generation apparatus 204 is not a request according to a specified method
The information management apparatus 202 fails to obtain a job ID or an image ID

In S906, the determination unit 520 sets a value representing the cause due to the caller side in the request result as the processing result by the determination unit 520.

In S907, the determination unit 520 determines whether the error cause, which is the error cause category determination result in S904, is a cause due to the summary information generation apparatus 204. If the determination result is true (YES in S907), the processing moves to S908. If the determination result is false (NO in S907), the processing moves to S909.

The causes due to the summary information generation apparatus 204 are as follows.
The summary information generation apparatus 204 fails to obtain an image from the information management apparatus 202
The summary information generation apparatus 204 fails to transmit a processing result to the information management apparatus 202
The summary information generation apparatus 204 fails to issue a time-limited reference for use to transmit a result of the summary information generation processing to the information management apparatus 202
An error occurs in an internal process by the summary information generation apparatus 204
No response is returned from the summary information generation apparatus 204 for a predetermined time

In S908, the determination unit 520 sets a value representing the cause due to the summary information generation apparatus 204 in the request result as the processing result by the determination unit 520. In S909, the determination unit 520 sets a value representing an undefined cause in the request result as the processing result by the determination unit 520.

After the setting of the processing result in S903, S906, S908, or S909 described above is completed, the flow in FIG. 9 is terminated.

The description now returns to FIG. 8. In S806, the control unit 511 determines the type of the subsequent process (response) determined in S805. If it is determined that the type of the response is success, the processing moves to S807. If it is determined that the type of the response is the cause due to the summary information generation apparatus 204, the processing moves to S808. If it is determined that the type of the response is the cause due to the caller side or the undefined cause, the flow in FIG. 8 is terminated.

In S807, the control unit 511 obtains the summary information from the location specified by the reference to the summary information contained in the response information, and stores the summary information into the holding unit 516.

In S808, the presence determination unit 521 determines whether the uploaded image is present in the holding unit 516. If the determination result indicates that the uploaded image is present in the holding unit 516 (YES in S808), the processing moves to S809. If the uploaded image is not present in the holding unit 516 (NO in S808), the flow in FIG. 8 is terminated.

In S809, the re-request unit 522 generates a time-limited reference to the uploaded image again, and transmits the time-limited reference to the summary information generation apparatus 204, thereby re-requesting the summary information generation apparatus 204 to generate the summary information. After the process of S808 is completed, the processing moves to S804.

### Details of Presence Determination Processing

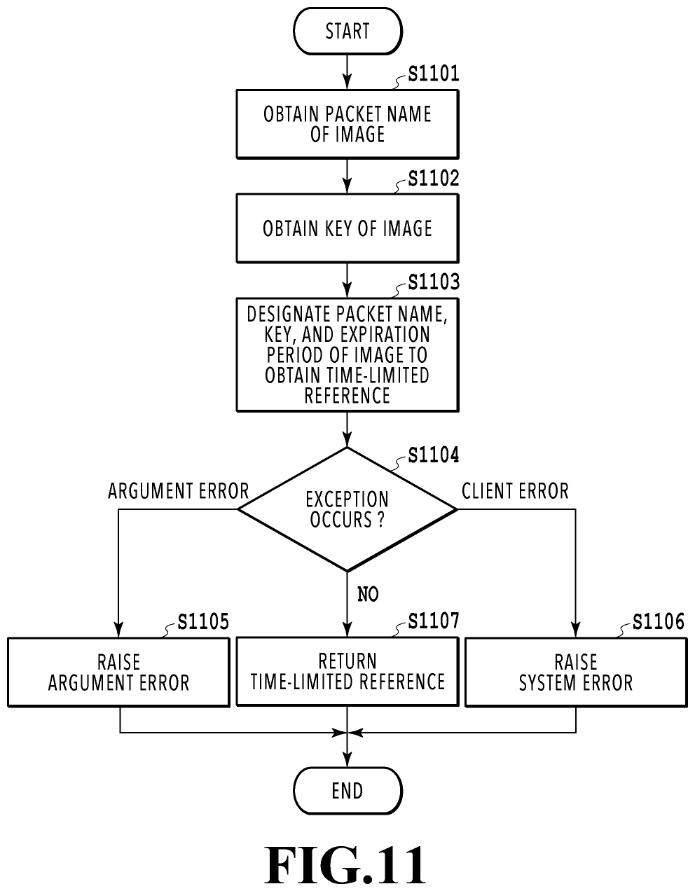

FIG. 11 is a flowchart illustrating a detailed flow of the presence determination processing (S617). The presence determination unit 521 executes the presence determination processing.

In S1101, the presence determination unit 521 obtains a packet name of an image from the storage unit 513. In S1102, the presence determination unit 521 obtains a key of the image from the storage unit 513. In S1103, the presence determination unit 521 designates the packet name, the key, and an expiration period of the image, and thereby obtains the time-limited reference to the image.

In S1104, the presence determination unit 521 determines whether an exception occurs and what is a type of the exception, and thereby determines a subsequent process to be executed by the presence determination unit 521. If the determination result indicates that an argument error occurs, the processing moves to S1105. If the determination result indicates that a client error occurs, the processing moves to S1106. If the determination result indicates that no exception occurs, the processing moves to S1107.

In S1105, the presence determination unit 521 throws an argument error and sends the error to the caller side. As a result, the argument error is raised on the caller side.

In S1106, the presence determination unit 521 throws a system error and sends the error to the caller side. As a result, the system error is raised on the caller side. In S1107, the presence determination unit 521 returns the time-limited reference to the caller side.

After the process of S1105, S1106, or S1107 described above is completed, the flow in FIG. 11 is terminated.

### Table Configuration

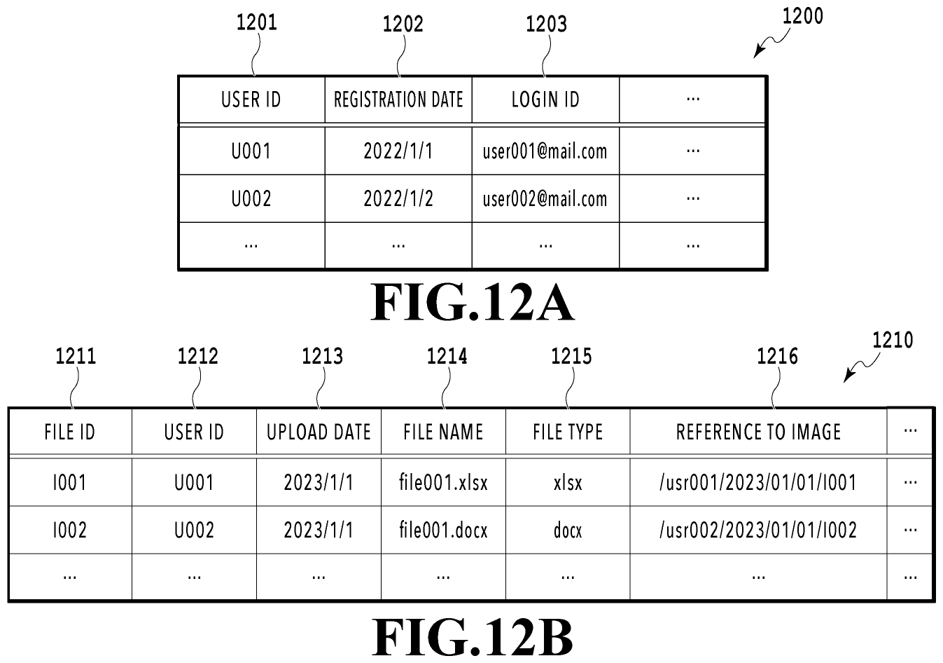

Using FIGS. 12A and 12B, description will be given of tables managed by the information management apparatus 202 according to the present embodiment. FIG. 12A is a diagram illustrating an example of a user table managed by the information management apparatus 202 in the present embodiment.

In a user table 1200, information pieces specified in items named a user ID 1201, a registration date 1202, and a login ID 1203 are managed while being associated with each other.

In the column of the user ID 1201, an information piece specifying a user ID for uniquely identifying a user, such for example as “U001” or “U002,” is stored. In the column of the registration date 1202, a registration date at which the user completed user registration to the information management apparatus 202 is stored. In the column of the login ID 1203, a login ID for login or the like is stored.

Since the registration date at which the user completed the user registration to the information management apparatus 202, and the login ID for login or the like are stored in association with the user ID for uniquely identifying a user, it is possible to refer to the registration date and the login ID by using the user ID as a key.

FIG. 12B is a diagram illustrating an example of a file table managed by the information management apparatus 202 in the present embodiment. The information management apparatus 202 manages a file table 1210.

In the file table 1210, information pieces specified in items named a file ID 1211, a user ID 1212, an upload date 1213, a file name 1214, a file type 1215, and an image reference 1216 are managed while being associated with each other.

In the column of the file ID 1211, an information piece specifying a file ID for uniquely identifying a file, such for example as “I001” or “I002,” is stored. In the column of the user ID 1212, an information piece specifying a user ID for uniquely identifying a user who is an owner of the file, such for example as “U001” or “U002,” is stored.

In the column of the upload date 1213, an upload date at which the user uploaded a file to the information management apparatus 202 is stored. In the column of the file name 1214, a file name, that is, the name of the file is stored. In the column of the file type 1215, an information piece specifying a file type is stored. In the column of the image reference 1216, an information piece specifying a storage location at which a target image is stored by a storage unit is stored.

In the file table 1210, the user ID specifying an owner of a file specified by the file ID, the upload date of the file, the file name, the file type, and the image reference are stored in association with the file ID. Thus, it is possible to refer to the user ID, the upload date, the file name, the file type, and the image reference by using the file ID as a key.

### Error Code List

FIG. 13 is a diagram for describing error codes to be output by the summary information generation apparatus 204 according to the present embodiment.

An error code list 1300 is a list of error codes to be output by the summary information generation apparatus 204, in which information pieces stored in items named an error code 1301 and a cause 1302 are managed while being associated with each other. In the error code 1301, an error code for uniquely identifying an error is stored. In the cause 1302, an error cause associated with the error code 1301 is specified.

### Error Cause Category Table

FIG. 14 is a diagram for describing an error cause category table. The information management apparatus 202 manages an error cause category table 1400.

In the error cause category table 1400, an information piece specified in the column of an error code 1401 and an information piece specified in the column of a category code 1402 are managed while being associated with each other.

Since the category code 1402 is stored in association with the error code 1401, it is possible to refer to the category code 1402 by using the error code 1401 as a hey. A category code C001 represents an error due to the summary information generation apparatus 204 and a category code C002 represents an error due to the caller side.

The reason why an error code E011 is categorized as C002 is as follows. Specifically, the error E011 is not caused by the summary information generation apparatus but is caused by a cloud infrastructure on which the summary information generation apparatus is built, such as a case where a virtual server instance in the cloud infrastructure is unexpectedly terminated abnormally, or a case where a gateway provided by the cloud infrastructure rejects the request for some reason.

As described above, in the present embodiment, the re-request control to control whether to make a re-request to generate the summary information of data the summary information generation apparatus is executed depending on a type of a response to a request to the summary information generation apparatus and the presence/absence of the data. Specifically, in a case where the type of the response is a failure to obtain the data by the summary information generation apparatus and the data is present in the information management apparatus, the control is executed so as to make the re-request to generate the summary information of the data to the summary information generation apparatus. In a case where the data is not present in the information management apparatus even though the type of the response is a failure to obtain the data by the summary information generation apparatus, the control is executed so as to cancel the re-request to generate the summary information of the data to the summary information generation apparatus. In this way, on the occasion to make a request to generate the summary information of an image, only in the case where the image is present and managed in the information management apparatus, the summary information generation apparatus is requested to generate the summary information of the image. This can reduce unnecessary requests.

Here, in a conceivable configuration, a summary information generation micro service (MS), which is a micro service for generating summary information, is prepared, and an image management cloud service requests the summary information generation MS to generate the summary information of an image managed by the image management cloud service by notifying the summary information generation MS of a reference to the image, and then uses the generated summary information of the image.

In this configuration, in a case where the summary information generation MS fails to obtain the image stored in the location specified by the reference due to an instantaneous disconnection of the communication with the image management cloud service, the summary information generation MS is requested to retry to obtain the image stored in the location specified by the reference.

However, there is a case where the image in the location specified by the reference is already deleted for the following reasons. A first case is that an uploaded image is inspected in terms of virus infection by the virus scan service and is deleted if the infection is detected. For example, this is a case where the image uploaded first is determined as valid, but the image uploaded second is determined as invalid because of duplicate activation or the like, and is deleted. A second case is that the image is deleted due to a cause in another system. To address this case, based on the idea of Design for Failure, it is recommended to build processing for dealing with a case where an image is deleted due to a cause in another system.

In a case where an uploaded image is deleted as in the foregoing two cases and the summary information generation MS fails to generate the summary information, an unnecessary retry is requested to the summary information generation MS.

According to the present embodiment, such an unnecessary request to generate the summary information is prevented.

### Second Embodiment

In the present embodiment, description will be given of a mode to determine a subsequent process depending on a processing status of a summary information generation apparatus. An overview and a configuration of an information management system, a hardware configuration of a terminal, and a hardware configuration of an information processing apparatus according to the present embodiment are the same as in the first embodiment, and therefore their description will be omitted herein. In the present embodiment, its differences from the first embodiment will be mainly described.

### Functional Configuration of Information Management System

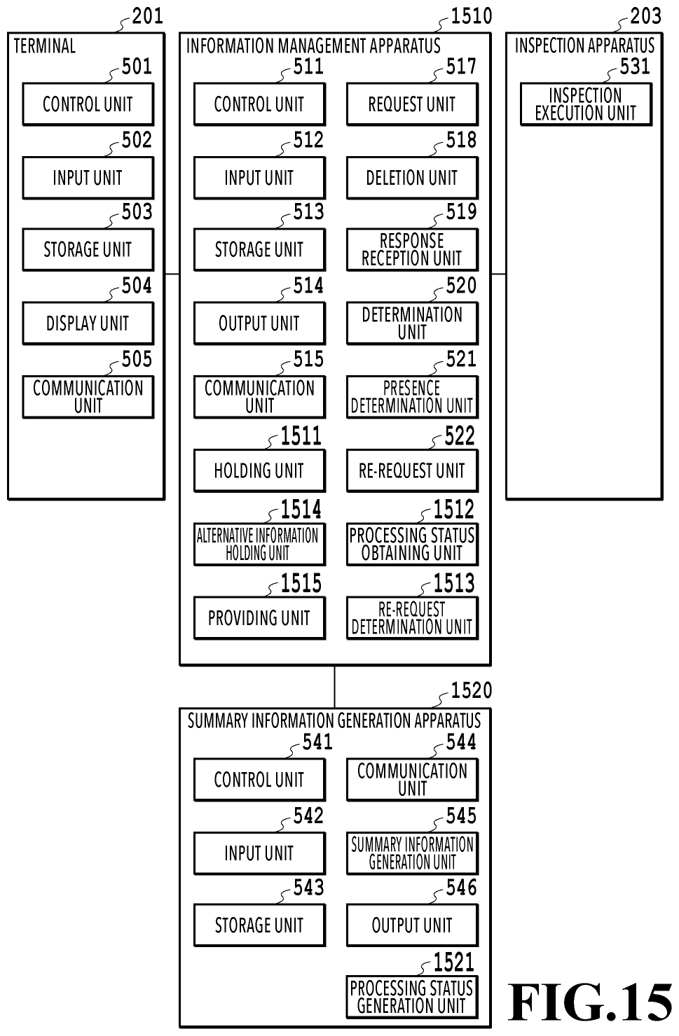

FIG. 15 is a diagram illustrating an example of a functional configuration of the information management system according to the present embodiment. The information management system in the present embodiment includes a terminal 201, an inspection apparatus 203, an information management apparatus 1510, and a summary information generation apparatus 1520.

### Functional Configuration of Information Management Apparatus

The CPU 401 of the information processing apparatus 400 that functions as the information management apparatus 1510 loads programs stored in the ROM 402 to the RAM 403 and executes the programs according to sequence charts and flowcharts to be described later to implement the functional configuration. Note that the result of each executed process is held in the RAM 403.

The information management apparatus 1510 has functional units 511 to 515 and 517 to 522 and additionally has a holding unit 1511, a processing status obtaining unit 1512, a re-request determination unit 1513, an alternative information holding unit 1514, and a providing unit 1515. Note that each of the functional units may perform part of functions of any other functional unit.

The holding unit 1511 holds information necessary for processing. The processing status obtaining unit 1512 obtains a processing status of summary information generation processing, which is processing of generating the summary information, in the summary information generation apparatus 1520. The re-request determination unit 1513 determines whether to re-request the summary information generation processing to generate the summary information based on the processing status of the summary information generation processing.

The alternative information holding unit 1514 holds alternative information. The alternative information refers to information such as an image, text, audio, and video that is to be provided to a user as an alternative to an uploaded image and the summary information in a case where they are not present. The providing unit 1515 provides the alternative information to the terminal 201 in a case where the uploaded image and the summary information are not present.

### Functional Configuration of Summary Information Generation Apparatus

The CPU 401 of the information processing apparatus 400 that functions as the summary information generation apparatus 1520 loads programs stored in the ROM 402 to the RAM 403 and executes the programs according to sequence charts and flowcharts to be described later to implement the functional configuration. Note that the result of each executed process is held in the RAM 403. Note that each of the functional units may perform part of functions of any other functional unit.

The summary information generation apparatus 1520 has functional units 541 to 546 and additionally has a processing status generation unit 1521. The processing status generation unit 1521 generates information specifying a processing status (processing status information) of the summary information generation processing by the summary information generation apparatus 1520.

### Flow of Processing in Information Management Apparatus 1510

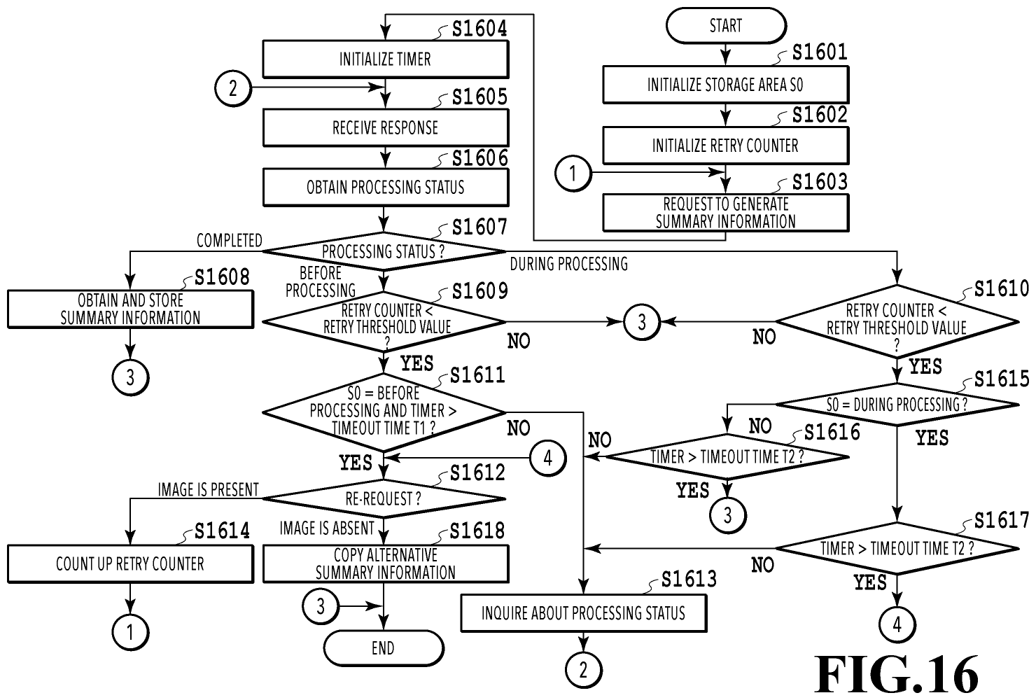

FIG. 16 is a diagram for describing a flow of processing by the information management apparatus 1510.

In S1601, the control unit 511 initializes a storage area S0 which stores a previous processing status which is a processing status stored as a result of making a previous request to generate the summary information to the summary information generation apparatus 1520. In S1602, the control unit 511 initializes a retry counter configured to count the number of retries.

In S1603, the request unit 517 requests the summary information generation apparatus 1520 to generate the summary information of an image. In S1604, the control unit 511 initializes a timer configured to measure an elapsed time after the summary information generation is requested. In S1605, the response reception unit 519 receives the response information from the summary information generation apparatus 1520.

In S1606, the processing status obtaining unit 1512 obtains the processing status information indicating the processing status from the response information. The response information has a processing status attribute indicating the processing status of the summary information generation processing. Thus, in the process of S1606, a value of the processing status attribute is obtained from the response information. The value of the processing status attribute indicates any one of a status before processing, a status during processing, and a completed status. The storage area S0 stores, as the processing status, “before processing” if the processing is not yet started, “during processing” if the processing is in progress, and “completed”if the processing is completed.

In S1607, the re-request determination unit 1513 determines a subsequent process to be executed by the information management apparatus 1510 based on the processing status. The processing moves to S1608 if the processing status is “completed,” moves to S1609 if the processing status is “before processing,” and moves to S1610 if the processing status is “during processing.”

In S1608, the control unit 511 obtains the summary information from the summary information generation apparatus 1520, and stores the summary information into the holding unit 1511.

In S1609, the re-request determination unit 1513 determines whether the value of the retry counter is less than a retry threshold value. The retry threshold value is, for example, 2. If the determination result is true (YES in S1609), the processing moves to S1611. If the determination result is false (NO in S1609), the flow in FIG. 16 is terminated.

In S1610, the re-request determination unit 1513 determines whether the value of the retry counter is less than the retry threshold value. If the determination result is true (YES in S1610), the processing moves to S1615. If the determination result is false (NO in S1610), the flow in FIG. 16 is terminated.

In S1611, the re-request determination unit 1513 determines whether the storage area S0 stores “before processing” and the timer exceeds a timeout time T1. The timeout time T1 is set to, for example, 130 seconds. In other words, the process of S1611 means to, in a case where the processing status is a first processing status (before processing), determine to make a re-request if a predetermined or longer time has passed after the previous request. If the determination result is true (YES in S1611), the processing moves to S1612. If the determination result is false (NO in S1611), the processing moves to S1613.

In S1612, the re-request determination unit 1513 determines whether the uploaded image is present and determines the subsequent process. If the uploaded image is determined to be present (YES in S1612), the processing moves to S1614. If the uploaded image is determined to be absent (NO in S1612), the processing moves to S1618. Since a re-request to generate the summary information is made if the uploaded image is present, this process in other words means to determine whether to make a re-request to generate the summary information.

In S1613, the processing status obtaining unit 1512 inquires of the summary information generation apparatus 1520 the processing status. After the process of S1613 is completed, the processing moves to S1605.

In S1614, the control unit 511 counts up the retry counter. Then, after the process of S1614 is completed, the processing moves to S1603.

In S1615, the re-request determination unit 1513 determines whether the storage area S0 stores “during processing.” If the status “during processing” is determined (YES in S1615), the processing moves to S1617. If a status other than “during processing”is determined (NO in S1615), the processing moves to S1616.

In S1616, the re-request determination unit 1513 determines whether the timer exceeds a timeout time T2. The timeout time T2 is set to, for example, 300 seconds. Note that the setting of the timeout time T2 is not limited to 300 seconds, and the timeout time T2 may be set to, for example, 130 seconds, as in the timeout time T1. If it is determined that the timer exceeds the timeout time T2 (YES in S1616), the flow in FIG. 16 is terminated. If it is determined that the timer does not exceed the timeout time T2 (NO in S1616), the processing moves to S1613.

In S1617, the re-request determination unit 1513 determines whether the timer exceeds the timeout time T2. In other words, the process of S1617 means to, in a case where the processing status is a second processing status (during processing), determine to make a re-request if a predetermined or longer time has passed after the previous request. If it is determined that the timer exceeds the timeout time T2 (YES in S1617), the processing moves to S1612. If it is determined that the timer does not exceed the timeout time T2 (NO in S1617), the processing moves to S1613.

In S1618, the providing unit 1515 obtains the alternative information from the alternative information holding unit 1514 and stores the alternative information to the storage location where the summary information is to be stored. Although the providing unit 1515 stores the alternative information to the storage location for the summary information in the above description, the present disclosure is not limited to this. For example, every time a request to obtain the summary information is received from the terminal, the alternative information may be transmitted. Moreover, it is possible to use any method capable of providing the alternative information to the user in a case where the summary information is not present. To provide some information to the user as described above makes it possible to avoid a situation where the user is confused because no information is provided to the user in a case where the summary information fails to be generated.

According to the present embodiment, the threshold value is set for the number of re-requests to generate the summary information as described above, and therefore unnecessary requests may be reduced.

The determination method by the re-request determination unit 1513 is not limited to the above method. The processing may be aborted halfway based on a timeout time different from the timeout time specified by the summary information generation apparatus 1520. In this way, it is possible to avoid making the user wait unnecessarily.

The information management apparatus may be configured to relocate an uploaded image as an error image and delete the uploaded image from the storage location to which the image is uploaded in the following cases: the request is retried a predetermined number of times without success; a no-retry-allowed error occurs; and a response enters a queue dedicated to error handling. In this way, it is possible to prevent the system or an administrator from inadvertently accessing an invalid image.

Moreover, The information management apparatus may be configured to automatically delete the relocated uploaded image after a lapse of a predetermined number of days such, for example, 30 days. In this way, it is possible to prevent the system or the administrator from inadvertently accessing an invalid image. Here, the predetermined number of days is not limited to 30 days. In a case where an operational scheme capable of identifying a cause immediately after an image is relocated and taking a measure against the cause is put into practice, the predetermined number of days may be set to a smaller number, such as 3 or 5 days. Instead, in order to enable re-verification to be performed later as needed, the predetermined number of days may be set to a larger number, such as 60 days.

In a case where the summary information of the image fails to be generated, a failure log may be collected and stored. The failure log contains, for example, an occurrence date and time when the failure to generate the summary information occurred, a user ID, and a file ID.

In the present embodiment, in a case where an uploaded image and the summary information are not present, the alternative information is provided. Note that the present disclosure is not limited to this. For example, the information management apparatus 1510 may internally include a summary information generation module and be configured to use this summary information generation module.

### Third Embodiment

In the present embodiment, description will be given of a mode to enable past results obtained by an information management apparatus to be checked. An overview and a configuration of an information management system, a hardware configuration of a terminal, and a hardware configuration of an information processing apparatus according to the present embodiment are the same as in the first embodiment, and therefore their description will be omitted herein. In the present embodiment, its differences from the first embodiment will be mainly described.

### Functional Configuration of Information Management System

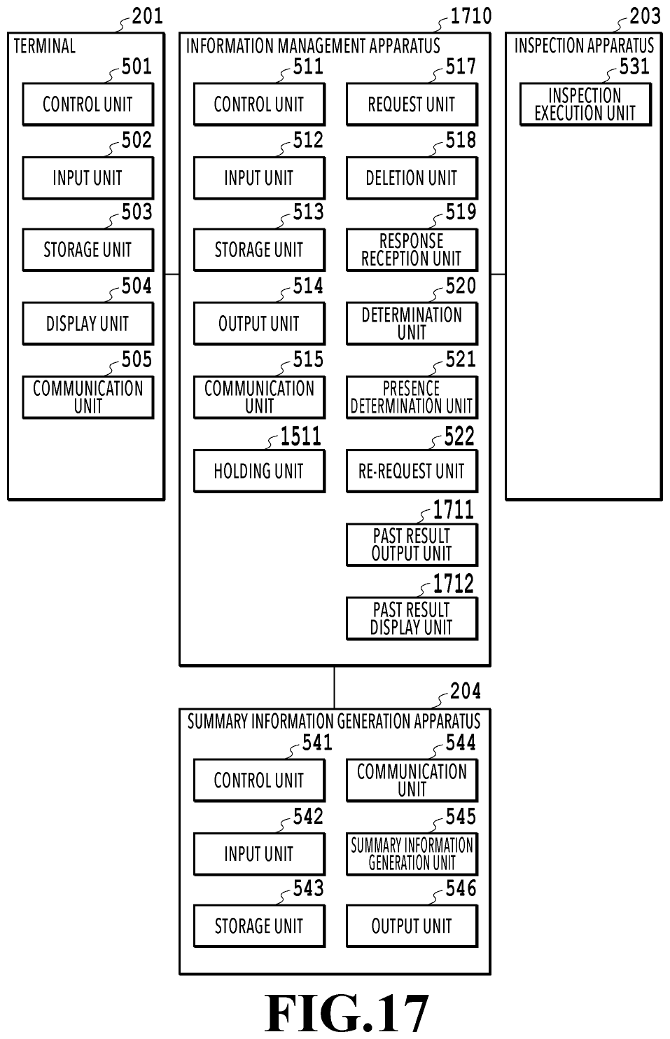

FIG. 17 is a diagram illustrating an example of a functional configuration of the information management system according to the present embodiment. The information management system in the present embodiment includes a terminal 201, an inspection apparatus 203, a summary information generation apparatus 204, and an information management apparatus 1710.

### Functional Configuration of Information Management Apparatus 1710

The CPU 401 of the information processing apparatus 400 that functions as the information management apparatus 1710 loads programs stored in the ROM 402 to the RAM 403 and executes the programs according to sequence charts and flowcharts to be described later to implement the functional configuration. Note that the result of each executed process is held in the RAM 403.

The information management apparatus 1710 has functional units 511 to 522, and additionally has a past result output unit 1711 and a past result display unit 1712. Note that each of the functional units may perform part of functions of any other functional unit.

The past result output unit 1711 outputs past result information in which the results of the requests to generate the summary information are recorded. The past result information is information containing reception time points and reception results from the summary information generation apparatus 204.

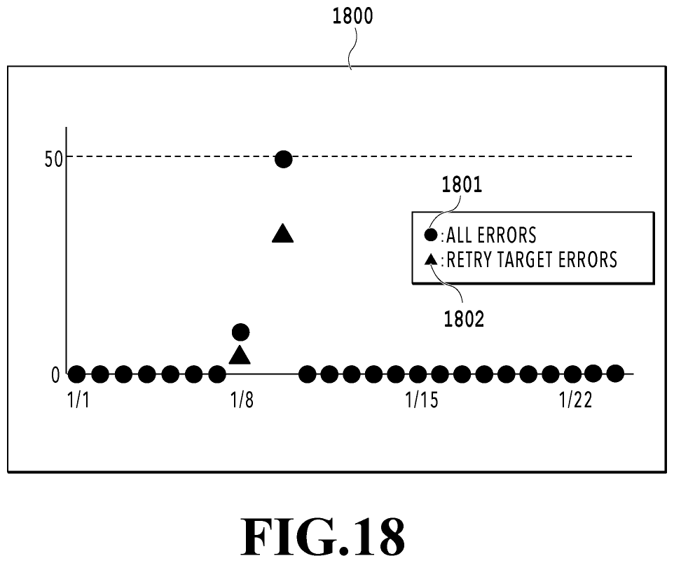

The past result display unit 1712 displays the past result information. The past result display unit 1712 displays a set of a total value of the reception results, which is added up at a predetermined aggregation granularity, and the corresponding one of the reception time points. Now, the aggregation granularity will be explained. An image reception is counted in response to an event where the user transmits an image from the terminal 201 and the information management apparatus 1710 receives the image. Thus, each reception occurs depending on the timing at which the user transmits an image, and accordingly receptions occur irregularly. Such irregular receptions are presented at the aggregation granularity with the intention of totaling the number of receptions for every certain period of time, such as every second or every minute, and managing the total value as the number of receptions for that time slot. In the example of FIG. 18, daily total values are plotted on a daily basis, and the aggregation granularity specifies what length of the time slot is used to display the total value.

### Configuration of UI

FIG. 18 is a diagram for describing a past result display screen generated by the information management apparatus 1710.

A UI screen 1800 displays a graph presenting numbers of errors per day. In the graph, the horizontal axis represents a time, and the vertical axis represents an error count per day. The scale on the horizontal axis is not limited to days, but may be any scale that is easy for the administrator to observe, such as seconds, minutes, hours, days, weeks, months, years, or any specified period.

A black circle 1801 represents the number of errors per day. A black triangle 1802 represents the number of retry target errors per day.

The UI screen 1800 is displayed on the display 404 of the information processing apparatus 400 that functions as the information management apparatus 1710. On the UI screen 1800 thus displayed on the display 404, the user can check the past result information in which the results of the requests to generate the summary information are recorded. In addition, since the reception time points at which the results of the summary information generation were received from the summary information generation apparatus and the reception results are displayed as the past result information, it is possible to check details of the past results of the summary information generation by the summary information generation apparatus.

Further, since the UI screen 1800 displays a graph presenting each set of the total value of the reception results, which is added up at the predetermined aggregation granularity, and the corresponding reception date and time (reception time point), it is possible to check the total number of errors and the number of retry target errors, which occurred in the summary information generation, on a daily basis.

In this regard, the information management apparatus 1710 may be configured to transmit a notification to an administrator of the information management apparatus 1710 in a case where the number of errors is equal to or more than a predetermined threshold value. The predetermined threshold value is set to, for example, 3. Note that the predetermined threshold value is not limited to this and may be set to 1 or 2.

According to the present embodiment, it is possible to reduce unnecessary requests to generate the summary information, and additionally enable the user to check the total number of errors and the number of retry target errors in the summary information generation on a predetermined scale such as a daily basis, as described above.

### Other Embodiments

The technology of the present disclosure can be embodied in the form of, for example, a system, an apparatus, a method, a program, a recording medium (storage medium), or the like. Specifically, the technology of the present disclosure may be applied to a system composed of multiple pieces of equipment (e.g., a host computer, an interface apparatus, an image capture apparatus, a web application, and so on) or an apparatus composed of a single piece of equipment.

Also, needless to say, the technology of the present disclosure may be implemented as below. Specifically, a recording medium (or storage medium) in which the program code (computer program) of software that implements the functions of the above-described embodiments is provided to a system or an apparatus. This storage medium is a computer-readable storage medium, as a matter of course. Also, a computer (or a CPU or micro processing unit (MPU)) of that system or apparatus reads out and executes the program code stored in the recording medium. In this case, the program code read out of the recording medium itself implements the functions of the above-described embodiments, and the technology of the present disclosure includes the recording medium in which the program code is recorded.

The present disclosure is not limited to the above-described embodiments, and may be modified in various ways and features of the above-described embodiments may be combined as appropriate.

The functional units included in the apparatuses constituting the information management system may be implemented by being distributed to multiple terminals and/or information processing apparatuses. In the case where the functions are distributed to multiple information processing apparatuses, the information processing apparatuses are connected so as to be capable of communicating with each other via a LAN or another network, and execute the aforementioned series of processing in collaboration.

Each of the functional units included the apparatuses constituting the information management system may be implemented by a CPU in the relevant apparatus executing the relevant program, but the present disclosure is not limited to this mode. In another example, hardware such as a graphics processing unit (GPU) or a field programmable gate array (FPGA) not illustrated may be used. Each functional unit may be implemented by software and hardware, such as a dedicated integrated circuit (IC), cooperating with each other, or some or all of the functions may be implemented solely by hardware.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-143345, filed Aug. 23, 2024, which is hereby incorporated by reference herein in its entirety.

What is claimed is:

1. An information management apparatus configured to manage data, comprising:
a request unit configured to make a request to generate summary information of the data to a summary generation apparatus configured to generate the summary information;
a deletion unit configured to delete the data; and
a re-request control unit configured to perform control whether to make a re-request to generate the summary information of the data to the summary generation apparatus, depending on a type of a response to the request and whether the data is present, wherein
the re-request control unit
performs control to make the re-request to generate the summary information of the data to the summary generation apparatus in a case where the type of the response is a failure to obtain the data by the summary generation apparatus and the data is present, and
performs control to cancel the re-request to generate the summary information of the data to the summary generation apparatus in a case where the data is not present even though the type of the response is the failure to obtain the data by the summary generation apparatus.

2. The information management apparatus according to claim 1, wherein the re-request control unit generates a time-limited reference to the data, and transmits the time-limited reference to the summary generation apparatus.

3. The information management apparatus according to claim 1, wherein the re-request control unit performs, in a case where an error is caused due to the summary generation apparatus, control to make the re-request to generate the summary information of the data to the summary generation apparatus.

4. The information management apparatus according to claim 3, wherein
the error caused due to the summary generation apparatus is at least one of:
an error in which the summary generation apparatus fails to obtain the data,
an error in which the summary generation apparatus fails to transmit a result of summary information generation processing,
an error in which the summary generation apparatus fails to issue a time-limited reference for use to transmit the result of the summary information generation processing,
an error that occurs in an internal process in the summary generation apparatus, and
an error in which a response from the summary generation apparatus is not returned for a predetermined time.

5. The information management apparatus according to claim 1, wherein the re-request control unit performs, in a case where an error is caused due to the information management apparatus, control to cancel the re-request to generate the summary information of the data to the summary generation apparatus.

6. The information management apparatus according to claim 5, wherein
the error caused due to the information management apparatus is at least one of:
an error in which a parameter used in a call to the summary generation apparatus issued by the information management apparatus is invalid,
an error in which an essential parameter is missing in a call to the summary generation apparatus issued by the information management apparatus,
an error in which a request header is missing in a call to the summary generation apparatus issued by the information management apparatus,
an error in which a type of a parameter used in a call to the summary generation apparatus issued by the information management apparatus is invalid,
an error in which a data format of the data is not supported by the summary generation apparatus,
an error in which the summary generation apparatus fails to execute a library to be internally called,
an error in which a call to a job management application programming interface (API) is failed, the job management API configured to issue a job ID of a job for managing a call inside the summary generation apparatus,
an error in which the summary generation apparatus fails to be authenticated in an attempt to access a location specified by a time-limited reference,
an error in which a path for communication of the information management apparatus with the summary generation apparatus is not encrypted,
an error in which a request made by the information management apparatus for calling the summary generation apparatus is not a request according to a specified method, and
an error in which the information management apparatus fails to obtain a job ID or an image ID.

7. The information management apparatus according to claim 1, further comprising:
an obtaining unit configured to obtain, from a response to the request, processing status information indicating a processing status in the summary generation apparatus; and
a re-request determination unit configured to determine whether to make the re-request to generate the summary information of the data to the summary generation apparatus, depending on the processing status indicated in the processing status information.

8. The information management apparatus according to claim 7, wherein the re-request determination unit determines, in a case where the processing status is a status before execution of the summary information generation processing and a predetermined or longer time has passed after the previous request, to make the re-request to generate the summary information of the data to the summary generation apparatus.

9. The information management apparatus according to claim 7, wherein the re-request determination unit determines, in a case where the processing status is a status during execution of the summary information generation processing and a predetermined or longer time has passed after the previous request, to make the re-request to generate the summary information of the data to the summary generation apparatus.

10. The information management apparatus according to claim 7, wherein the re-request determination unit aborts processing halfway based on a second timeout time that is different from a first timeout time specified by the summary generation apparatus.

11. The information management apparatus according to claim 7, wherein the re-request determination unit relocates the data in a case where the re-request fails a predetermined number of times.

12. The information management apparatus according to claim 11, wherein the relocated data is deleted after a lapse of a predetermined number of days.

13. The information management apparatus according to claim 7, comprising:
an alternative information holding unit configured to hold alternative information to be used as alternative to the summary information; and
a providing unit configured to provide, in a case where the data and the summary information are not present, the alternative information held in the alternative information holding unit.

14. The information management apparatus according to claim 13, wherein the providing unit stores the alternative information into a storage location where the summary information is to be stored.

15. The information management apparatus according to claim 13, wherein the providing unit transmits the alternative information in response to every request to obtain the summary information from a terminal having transmitted the data to the information management apparatus.

16. The information management apparatus according to claim 1, further comprising an output unit configured to output past result information in which a result of a request to generate the summary information is recorded, wherein
the past result information contains a reception time point and a reception result from the summary generation apparatus.

17. The information management apparatus according to claim 16, further comprising a display unit configured to display a set of a total value of the reception results added up at a predetermined aggregation granularity and the corresponding reception time point.

18. The information management apparatus according to claim 1, wherein the summary information of the data is information that enables what type of data the data is to be identified.

19. The information management apparatus according to claim 1, wherein in a case where the data is of an image, the summary information of the data contains at least one of a thumbnail of the image, image capture information of the image, and a feature quantity of the image.

20. The information management apparatus according to claim 1, further comprising a data holding unit configured to hold the data, wherein
the deletion unit deletes the data held by the data holding unit.

21. An information management method for managing data, comprising:
making a request to generate summary information of the data to a summary generation apparatus configured to generate the summary information;
deleting the data;
controlling whether to make a re-request to generate the summary information of the data to the summary generation apparatus, depending on a type of a response to the request and whether the data is present, wherein
the controlling whether to make a re-request includes
performing control to make the re-request to generate the summary information of the data to the summary generation apparatus in a case where the type of the response is a failure to obtain the data by the summary generation apparatus and the data is present, and
performing control to cancel the re-request to generate the summary information of the data to the summary generation apparatus in a case where the data is not present even though the type of the response is the failure to obtain the data by the summary generation apparatus.

22. A non-transitory computer readable storage medium storing a program for causing a computer to perform an information management method for managing data, the information management method comprising:
making a request to generate summary information of the data to a summary generation apparatus configured to generate the summary information;
deleting the data;
controlling whether to make a re-request to generate the summary information of the data to the summary generation apparatus, depending on a type of a response to the request and whether the data is present, wherein
the controlling whether to make a re-request includes
performing control to make the re-request to generate the summary information of the data to the summary generation apparatus in a case where the type of the response is a failure to obtain the data by the summary generation apparatus and the data is present, and
performing control to cancel the re-request to generate the summary information of the data to the summary generation apparatus in a case where the data is not present even though the type of the response is the failure to obtain the data by the summary generation apparatus.

23. An information management system comprising:
an information management apparatus; and
a summary generation apparatus, wherein
the information management apparatus includes
a request unit configured to make a request to generate summary information of the data to a summary generation apparatus configured to generate the summary information;
a deletion unit configured to delete the data; and
a re-request control unit configured to control whether to make a re-request to generate the summary information of the data to the summary generation apparatus, depending on a type of a response to the request and whether the data is present, and
the re-request control unit
performs control to make the re-request to generate the summary information of the data to the summary generation apparatus in a case where the type of the response is a failure to obtain the data by the summary generation apparatus and the data is present, and
performs control to cancel the re-request to generate the summary information of the data to the summary generation apparatus in a case where the data is not present even though the type of the response is the failure to obtain the data by the summary generation apparatus.
